(19) United States
(12) Patent Application Publication
(10) Pub. No.: US 2024/0272357 A1
(43) Pub. Date: Aug. 15, 2024

(54) SEMICONDUCTOR STRUCTURE AND METHOD OF MANUFACTURE

(71) Applicant: SMART Photonics Holding B.V., Eindhoven (NL)

(72) Inventors: Alonso Jesús MILLÁN-MEJÍA, Eindhoven (NL); Paul TIEBOT, Eindhoven (NL)

(21) Appl. No.: 18/641,731

(22) Filed: Apr. 22, 2024

Related U.S. Application Data
(63) Continuation-in-part of application No. 18/431,872, filed on Feb. 2, 2024.
Application No. 18/431,872 is a continuation of application No. PCT/EP2022/071880, filed on Aug. 3, 2022.

(30) Foreign Application Priority Data
Aug. 5, 2021 (GB) 2111320.4

(51) Int. Cl. G02B 6/122; G02B 6/132; G02B 6/136

(52) U.S. Cl. CPC G02B 6/1228; G02B 6/1223; G02B 6/132; G02B 6/136

(57) ABSTRACT

A spot-size converter for a photonic integrated circuit, comprising a substrate, and a waveguide. The waveguide comprises a first waveguide portion and a second waveguide portion. The first waveguide portion is on a first portion of the substrate. The second waveguide portion is on a second portion of the substrate. A size of the first waveguide portion in a first direction perpendicular to a light propagation direction of the waveguide is less than a size of the second waveguide portion in the first direction.

### CROSS-REFERENCE TO RELATED APPLICATIONS

This application is a continuation-in-part under 35 U.S.C. § 120 of U.S. application Ser. No. 18/431,872 filed Feb. 2, 2024, which is a continuation under 35 U.S.C. § 120 of International Application No. PCT/EP2022/071880, filed Aug. 3, 2022 which claims priority to United Kingdom Application No. GB 2111320.4, filed Aug. 5, 2021, under 35 U.S.C. § 119(a). Each of the above-referenced patent applications is incorporated by reference in its entirety.

### BACKGROUND

Semiconductor structures can be used in photonic integrated circuits (PICs) to perform various functions. In some applications, light may be input into or output from the PIC. For example, light is output from the PIC into an optical fibre which carries the output light to another device as input. In some examples, it is desirable to modify the light before it is output so that it is suitable for the optical fibre.

### BRIEF DESCRIPTION OF THE DRAWINGS

FIG. 1 illustrates schematically a first side cross-section of a first semiconductor structure according to examples;

FIG. 2 illustrates schematically a plan cross-section of the first semiconductor structure according to examples;

FIG. 3 illustrates schematically a second side cross-section of the first semiconductor structure according to examples;

FIG. 4 illustrates a plan cross-section of a second semiconductor structure according to examples;

FIG. 5 illustrates a plan cross-section of a third semiconductor structure according to examples;

FIG. 6 illustrates schematically a side cross-section of the third semiconductor structure according to examples;

FIG. 7 illustrates part of a method of manufacturing a semiconductor structure according to examples;

FIGS. 8a-8d each illustrate schematically a side cross section of a semiconductor structure at sequential stages during manufacture according to examples;

FIG. 9 illustrates part of the method of manufacturing the semiconductor structure according to examples;

FIG. 10 illustrates schematically a top plan view, a side cross-section and a plan cross-section of a spot size converter of further examples;

FIG. 11 is a flow diagram of a method of manufacturing the spot size converter of FIG. 10;

FIG. 12 illustrates schematically a top plan view, three side cross-sections and a plan cross-section of a spot size converter of further examples;

FIG. 13 is a flow diagram of a part of a method of manufacturing the spot size converter of FIG. 12;

FIG. 14 illustrates schematically side cross-sections of a spot size converter of further examples during a method of manufacturing the spot size converter;

FIG. 15 is a flow diagram of a method of manufacturing the spot size converter of FIG. 14;

FIG. 16 illustrates schematically side cross-sections of a spot size converter of further examples during a method of manufacturing the spot size converter;

FIG. 17 is a flow diagram of a method of manufacturing the spot size converter of FIG. 16;

FIG. 18 illustrates schematically side cross-sections of a spot size converter of further examples during a method of manufacturing the spot size converter; and

FIG. 19 is a flow diagram of a method of manufacturing the spot size converter of FIG. 18.

### DETAILED DESCRIPTION

Examples described herein relate to a semiconductor structure for a PIC. More specifically, examples described herein relate to a semiconductor structure which, when in use, converts the spot size of light propagating through the spot size converter.

Light can be input into a PIC from an optical fibre or output from a PIC to an optical fibre. Light propagating within a PIC has a spot size appropriate for the physical size of the components of the PIC, such as the waveguides. However, optical fibres are typically for carrying light with a larger spot size. In the context of light being output to an optical fibre, it is desirable to increase the spot size of the light before it is output to the optical fibre.

As used herein, spot size relates to the cross-sectional area of a beam of light in a plane perpendicular to the direction in which the light is propagating. For example, the magnitude of the spot size in each of two orthogonal directions (e.g. width and height) can be changed by examples of the semiconductor structure described herein. As explained later, the size of the spot in two orthogonal directions (e.g. height and width) can be changed directly proportionally to each other, so that the shape of the beam's cross-sectional area is e.g. the same before and after the first and second spot size conversions. In other examples, by changing the size in the two orthogonal directions differently to each other, in accordance with a pre-determined ratio, the shape of the cross-sectional area after the first and second spot size conversions can be changed relative to before the conversions. Those skilled in the art will appreciate that there are various definitions of a spot of a beam of light and what is taken as its cross-sectional area. E.g., a beam diameter of light can be used to define the spot size. One definition is the full width at half maximum (FWHM), which relates to the width of the intensity profile (in a direction perpendicular to the light propagation direction) at half of the peak intensity of the light. Other definitions include 1/e² and D4Σ (second moment width), as the skilled person will appreciate.

The following discussion relates to converting the spot size of light within a PIC in two directions, each perpendicular to one another and to the light propagation direction.

For spot size conversion in two orthogonal directions which are perpendicular to the light propagation direction, a semiconductor structure for spot size conversion is desired which is easier to manufacture, e.g. monolithically and/or without needing to provide waveguide layers at different vertical levels within a structure, and/or without needing to create tapers in layer thickness using wet etching techniques that result in undesirably rough surfaces of a waveguide.

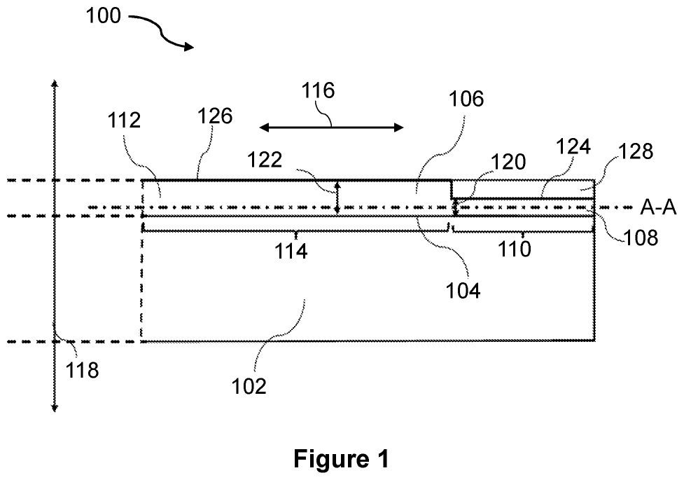

FIG. 1 illustrates schematically a side cross-section of a semiconductor structure 100 for a PIC according to examples. Other examples of a semiconductor structure for spot size conversion are described later. The semiconductor structure 100 is for converting a spot size of light. The semiconductor structure 100 is hereafter simply referred to as the structure 100 for brevity. The structure 100 comprises a substrate 102 comprising a planar surface 104. The planar surface 104 is substantially planar, so is for example planar or flat, e.g. within acceptable functional and manufacturing tolerances, or more generally planar in that it corresponds to a single plane.

The structure 100 comprises a waveguide 106. In these examples, the waveguide 106 comprises a first waveguide portion 108 tapered for a first spot size conversion of light and in contact with a first portion 110 of the planar surface 104. In these examples, the structure 100 comprises a second waveguide portion 112 in contact with a second portion 114 of the planar surface 104. The second portion of the planar surface is next to the first portion of the planar surface, e.g. so that in examples the first waveguide portion contacts the second waveguide portion. A size of the first waveguide portion 108 in a first direction 118 perpendicular to a light propagation direction 116 is less than a size of the second waveguide portion 112 in the first direction 118 for a second spot size conversion of the light. In the examples of FIG. 1, the substrate 102, the first waveguide portion 108 and the second waveguide portion 112 are monolithically integrated in the semiconductor structure 100. In the orientation shown in FIG. 1, the light propagation direction extends between the left and right of the page.

For example, particular optical modes of light are desired to propagate through the waveguide 106 depending on the desired application of the region of the PIC in question. The direction in which the optical modes propagate within the waveguide 106 is herein referred to as the light propagation direction. The light propagation direction is the general direction in which the energy of the optical mode travels through the waveguide 106 and is not necessarily, for example, the direction defined by the angle of incidence at a boundary of the waveguide 106. As described above, in the examples of FIG. 1, the light propagation direction is indicated by the arrow 116. In some applications, light propagates from left to right in the orientation of FIG. 1, while in other applications, light propagates from right to left in the orientation of FIG. 1.

In the examples of FIG. 1, the first waveguide portion 108 and the second waveguide portion 112 are of the same material. In other examples, the first waveguide portion 108 and the second waveguide portion 112 are of different materials to one another, e.g. depending on the application.

In the examples of FIG. 1, the waveguide 106 comprises a material which has a higher refractive index than the material of the substrate 102. For example, the waveguide 106 comprises Indium Gallium Arsenide Phosphide (InGaAsP). More generally, in some examples, the waveguide 106 comprises (Al)InGaAs(P). The elements indicated in the parentheses can be interchangeable and the composition of the different elements is selected depending on the desired function. For example, the composition of Ga and As in InGaAs can be selected according to the desired bandgap.

In the examples of FIG. 1, the first direction 118 is substantially (within acceptable tolerances) perpendicular to the planar surface 104. In other examples, the first direction is oriented differently, as described further below. In the examples of FIG. 1, the first direction 118 is the vertical direction with respect to the orientation of FIG. 1, as indicated by the arrow indicated by the numeral 118. Accordingly, in these examples, the size 120 of the first waveguide portion 108 in the first direction 118 is the thickness of the first waveguide portion 108. In these examples, the size 122 of the second waveguide portion 112 in the first direction 118 is the thickness of the second waveguide portion 112.

The size 120 of the first waveguide portion 108 in the first direction 118 in the examples of FIG. 1 is hereafter referred to as the thickness 120 of the first waveguide portion 108. The size 122 of the second waveguide portion 112 in the first direction 118 in the examples of FIG. 1 is hereafter referred to as the thickness 122 of the second waveguide portion 112.

In the examples of FIG. 1, the first waveguide portion 108 is thinner than the second waveguide portion 112. Both the first and second waveguide portions 108, 112 are in contact with the planar surface 104 such that they are on the same plane as each other.

The difference in the size of the first and second waveguide portions 108, 112 in the first direction 118 at least partly provides the second spot size conversion. In other words, the difference in thickness between the first and second waveguide portions 108, 112 at least partly provides the second spot size conversion of the light. In these examples, the second spot size conversion is a change in spot size in the first direction 118. In these examples, the second spot size conversion is an increase of the spot size in the first direction 118 for light propagating from the second waveguide portion 112 to the first waveguide portion 108. This results from the smaller thickness 120 of the first waveguide portion 108. In these examples, the thickness 120 of the first waveguide portion 108 is not enough to effectively confine, in the first direction 118, the mode of light in question as compared to the second waveguide portion 112 with the greater thickness 120. Therefore, the mode of light in question expands in the first direction 118 and the spot size in the first direction 118 becomes larger as the mode of light in question passes into the first waveguide portion 108.

A difference in the thickness of different waveguide portions can be achieved in different ways. In the examples of FIG. 1, the size 120 of the first waveguide portion 108 in the first direction 118 is less than the size 122 of the second waveguide portion 112 in the first direction 118, such that a surface 124 of the first waveguide portion 108 is stepped relative to a surface 126 of the second waveguide portion 112, the surface 124 of the first waveguide portion 108 next to the surface 126 of the second waveguide portion 112. The manner in which the stepped surface is manufactured is described further below. Providing a stepped surface such as that shown in the examples of FIG. 1 has manufacturing advantages as compared to providing a thickness taper, for example. For example, performing wet etching to provide a thickness taper can provide a rough tapered surface of the waveguide portion in question. This is undesirable for some applications e.g. where optical losses due to a rough tapered surface would be too great for the intended application.

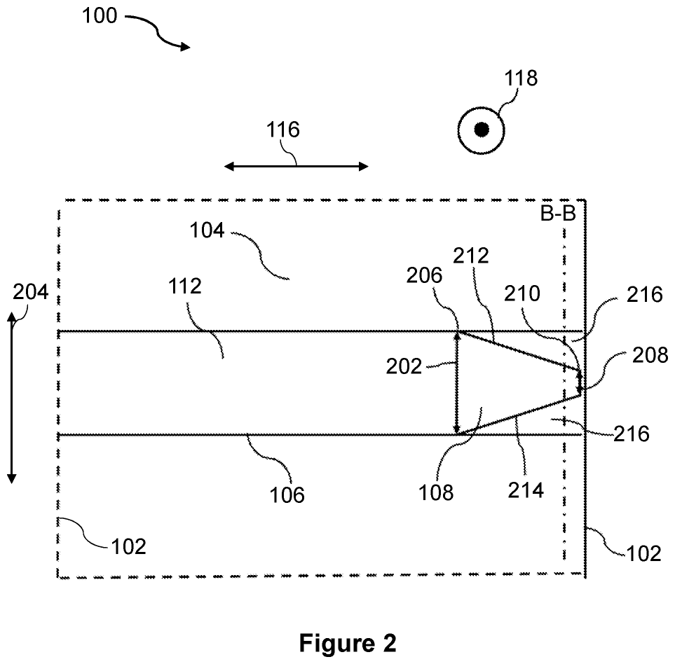

FIG. 2 illustrates schematically a plan view cross section of the structure 100 according to examples. The cross section shown in FIG. 2 is take at line A-A indicated in FIG. 1. The examples of FIG. 2 show the manner in which the first waveguide portion 108 is tapered according to these examples. The taper of the first waveguide portion 108 provides a geometry which at least partly provides the first spot size conversion of the light, as will be discussed further below. It should be noted that the first spot size conversion as referred to herein relates to a change in spot size provided for by the taper of the first waveguide portion 108 as described below.

In the examples of FIG. 2, a size 202 of the first waveguide portion 108 in a second direction 204, perpendicular to the first direction 118 and the light propagation direction 116, at a first location 206 along the light propagation direction 116 is greater than a size 208 of the first waveguide portion 108 in the second direction 204 at a second location 210 along the light propagation direction 116. In these examples, the first location 206 is closer to the second waveguide portion 112 than the second location 210. The size in the second direction 204 can be referred to as the width of the portion in question.

In the examples of FIG. 2, the first location 206 corresponds to a part of the first waveguide portion 108 closest to the second waveguide portion 112, and the second location 210 corresponds to a part of the first waveguide portion 108 farthest from the second waveguide portion 112. In the examples of FIG. 2, the width 202 of the first waveguide portion 108 at the first location 206 is substantially (within acceptable tolerances) the same as the width (size in the second direction 204) of the second waveguide portion 112 where the first waveguide portion 108 contacts the second waveguide portion 112.

The geometry of the first waveguide portion 108 is different depending on the position along the light propagation direction 116. The geometry is different in that the width of the first waveguide portion 108 is different depending on the position along the light propagation direction 116. This at least partly provides the first spot size conversion of the light which is a change in the spot size in the second direction 204. In these examples, the first spot size conversion is an increase of the spot size in the second direction 204 for light propagating through the first waveguide portion 108 away from the second waveguide portion 112.

For example, as the mode of light in question propagates from a larger width part of the first waveguide portion 108 to a smaller width part of the first waveguide portion 108, the mode of light becomes less confined width wise and the spot size in the second direction 204 increases.

The first spot size conversion is at least partly the result of the width geometry of the first waveguide portion 108. The magnitude of the first spot size conversion depends on a magnitude of a change in size of the first waveguide portion 108 in the second direction 204, and hence the proportions of the first waveguide portion. In other words, the magnitude of the first spot size conversion depends on the change in width, e.g. a width difference, of the first waveguide portion 108 along the second direction. Such a width difference is for example the difference between the largest width of the first waveguide portion 108 and the smallest width of the first waveguide portion 108. In the examples of FIG. 2, such a width difference is the difference between the width 202 at the first location 206 and the width 208 at the second location 210.

In the examples of FIG. 2, the first waveguide portion 108 comprises a first surface 212 and a second surface 214. Each of the first surface 212 and the second surface 214 extends away from the planar surface 104. For example, the first and second surfaces 212, 214 extend in the first direction 118. In the examples of FIG. 2, the first and second surface 212, 214 is substantially (within acceptable tolerances) flat. In the examples of FIG. 2, the taper of the first waveguide portion 108 is provided by the first and second surfaces 212, 214 being at an acute angle relative to the second direction 204 such that at a location progressively farther away from the second waveguide portion, the size of the first waveguide portion 108 in the second direction is less.

In other examples, instead of the first and second surfaces 212, 214 being substantially flat and angled relative to the second direction 204 as described, there are provided side surfaces with stepped portions. Such side surfaces, for example, comprise a plurality of stepped portions such that at a location progressively farther away from the second waveguide portion 112, the width of the first waveguide portion 108 is less. In such examples, the taper of the first waveguide portion 108 is provided in a stepped manner.

As described above, in examples, the second spot size conversion is in the first direction 118, and the first spot size conversion is in the second direction 204. Using a combination of the first and second spot size conversion, the spot size of light in the plane perpendicular to the light propagation direction 116 can be controlled.

As described above, the second spot size conversion depends on the difference in the size of the first and second waveguide portions 108, 112 in the first direction 118 (referred to in the following as a first size difference for brevity), and the first spot size conversion depends on the magnitude of the change in size of the first waveguide portion 108 in the second direction 204 (referred to in the following as a second size difference for brevity). As will be appreciated, the first and second waveguide portions are proportioned, for example in accordance with a pre-determined ratio between the first size difference and the second size difference, such that the first spot size conversion is greater in magnitude than the second spot size conversion; the second spot size conversion is greater in magnitude than the first spot size conversion; or the first spot size conversion and the second spot size conversion being substantially equal in magnitude.

The following relates to illustrative examples in which light propagating in the second waveguide portion 112 has a spot size in the first and second directions that provides a substantially circular spot. In these examples, light propagates from the second waveguide portion 112 towards the first waveguide portion 108. In some such examples with the first spot size conversion greater in magnitude than the second spot size conversion, the light output from the first waveguide portion 108 corresponds to a non-circular elliptical spot greater in size in the first direction 118 than in the second direction 204. In other such examples instead having the second spot size conversion greater in magnitude than the first spot size conversion, the light output from the first waveguide portion 108 corresponds to a non-circular elliptical spot greater in size in the second direction 204 than in the first direction. In further such examples instead having the first spot size conversion and the second spot size conversion being substantially equal in magnitude, the light output from the first waveguide portion 108 corresponds to a substantially circular spot. Accordingly, changing the described ratio in the design of the semiconductor structure can be used to change the size and, in some examples, also the shape of the spot of light. The pre-determined ratio depends on the desired application. For example, the pre-determined ratio depends on the cross-section of the optical fibre to which the structure 100 is intended to optically couple.

Referring again to FIG. 1, in these examples, the structure 100 comprises a cladding layer 128 in contact with the first waveguide portion 108. The cladding layer 128 overlaps the first portion 110 of the planar surface 104. In the examples of FIG. 1, the cladding layer 128 is on top of the first waveguide portion 108 with respect to the orientation shown in FIG. 1. In these examples, the combined thickness (size in the first direction 118) of the first waveguide portion 108 and the cladding layer 128 is substantially (within acceptable tolerances) the same as the thickness of the second waveguide portion 112. The cladding layer 128 is of a material with a lower refractive index than the material of the first waveguide portion 108. The material of the cladding layer 128 may be referred to as the cladding material. As used herein, cladding material is a material other than air. However, the difference in refractive index between the first waveguide portion and the cladding layer 128 is low enough to provide deconfinement of the desired optical mode of light propagating within the first waveguide portion 108 to at least partly provide the spot size conversion. Those skilled in the art will appreciate that the higher the refractive index difference, the stronger the confinement.

In the examples of FIG. 2, the structure 100 comprises cladding material 216 in contact with the first surface 212 and the second surface 214. Cladding material 216 in contact with the first and second surfaces 212, 214 provide a lower refractive index difference at the boundaries provided by the first and second surfaces 212, 214 than if the first and second surfaces 212, 214 were in contact with air, for example. This provides for deconfinement of the desired optical mode in the second direction 204.

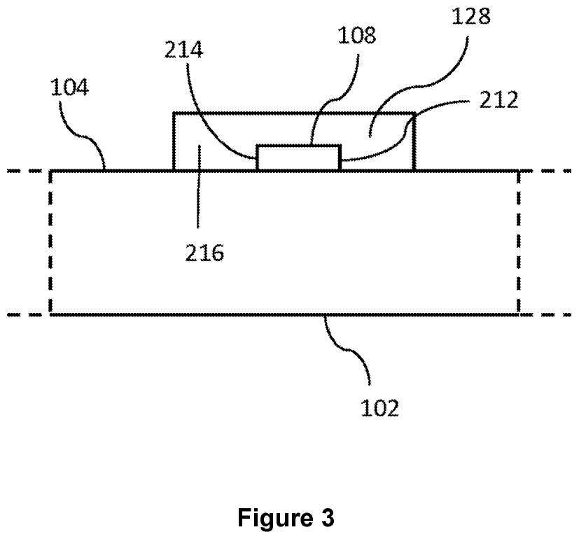

FIG. 3 illustrates schematically a side cross section of the structure 100 along the line B-B shown in FIG. 2. It can be seen from FIG. 3 that, in these examples, there is cladding material 216 in contact with the first surface 212 and the second surface 214.

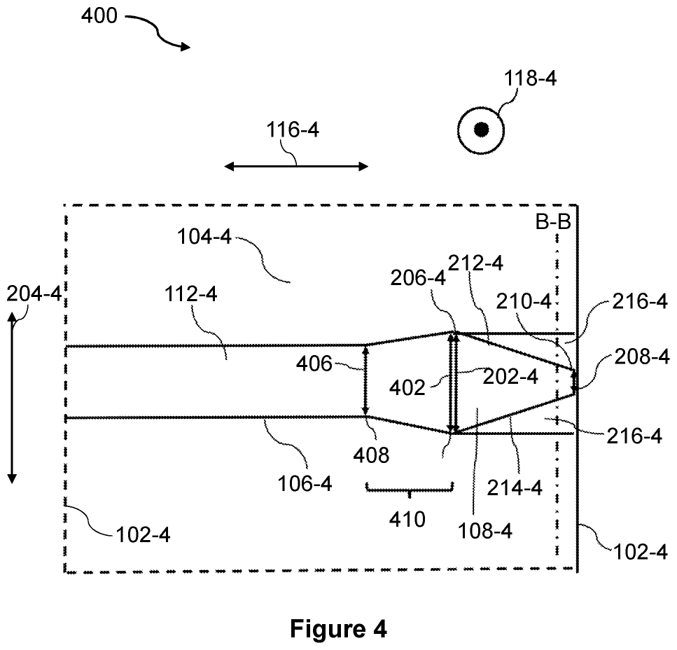

FIG. 4 illustrates schematically the same plan view cross section as that of FIG. 2 but for a semiconductor structure 400 according to different examples. Features corresponding to those shown in FIGS. 1-3 are labelled with similar reference numerals with the additional numeral “−4” added at the end in FIG. 4. The structure 400 has any combination of the features described above with respect to the structure 100. In addition, the examples of FIG. 4 have the following features.

In the examples of FIG. 4, a size 402 of the second waveguide portion 112-4 in the second direction 204-4 at a third location 404 along the light propagation direction 116-4 is greater than the size 406 of the second waveguide portion 112-4 in the second direction 204-4 at a fourth location 408 along the light propagation direction 116-4. In these examples, the third location 404 is closer to the first waveguide portion 108 than the fourth location 408. As described above, the second direction 204-4 is perpendicular to the first direction 118-4 (out of the page in FIG. 4) and the light propagation direction 116-4. In these examples, the second waveguide portion 112-4 comprises a section 410 with a taper in which the width is greater closer to the first waveguide portion 108-4 as shown. In these examples, the width of the second waveguide portion 112-4 is greater closer to the first waveguide portion 108-4 such that the widths of the first and second waveguide portion 108-4, 112-4 are similar to one another where the second waveguide portion 112-4 contacts the first waveguide portion 108-4. For example, the second waveguide portion 112-4 other than the section 410 has a smaller width (compared to the width where the first and second waveguide portions 108-4, 112-4 meet) in accordance with the desired application. However, closer to the first waveguide portion 108-4, the width of the second waveguide portion 112-4 is tapered so that it is similar to the width of the first waveguide portion 108-4 where the first and second waveguide portions 108-4, 112-4 contact one another. In some examples, the first and second waveguide portions 108-4, 112-4, where they contact one another, have substantially (within acceptable manufacturing tolerances) matching widths, which can give low losses for light propagating from one portion to the other. The section 410 tapered to have a greater width closer to the first waveguide portion 108-4 provides for the first and second waveguide portions 108-4, 112-4 being positioned relative to each other, for light coupling therebetween, with less strict tolerances.

In the examples described above, the first direction 118, 118-4 is substantially perpendicular to the planar surface 104, 104-4. However, in other examples, the first direction is substantially parallel to the planar surface of the substrate, with the second direction perpendicular to the first direction. In these examples, the first and second directions are perpendicular to the light propagation direction. In these examples, as for the examples described above, a size of the first waveguide portion in the first direction is less than a size of the second waveguide portion in the first direction for a second spot size conversion.

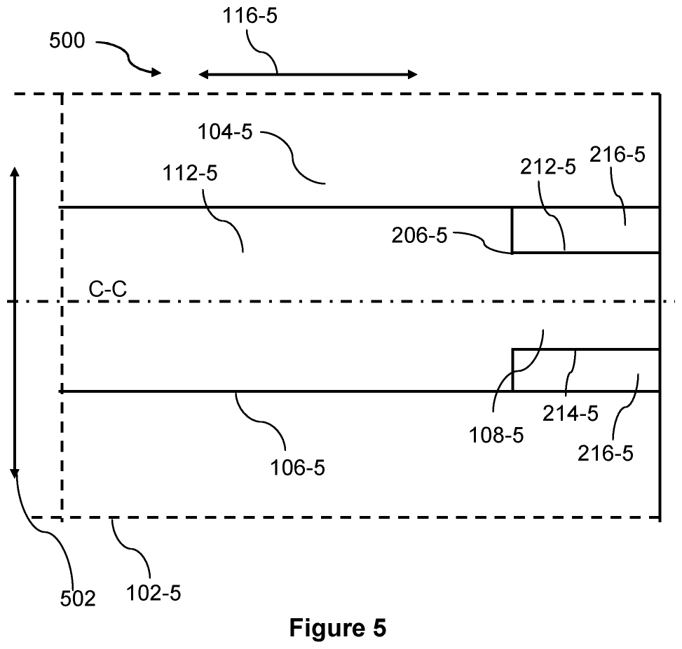

FIG. 5 illustrates schematically the same plan view cross section as that of FIG. 2 but for a semiconductor structure 500 according to further examples. Features corresponding to those shown in FIGS. 1-4 are labelled with similar reference numerals with the additional numeral “−5” added at the end in FIG. 5. The structure 500 has any combination of the features described above with respect to the structures 100 and 400, except for the following differences.

In the examples of FIG. 5, the first direction 502 is perpendicular to the light propagation direction 116-5, and parallel to the planar surface 104-5 of the substrate 102-5. In these examples, a size in the first direction 502 can be referred to as a width. The width of the first waveguide portion 108-5 is less than the width of the second waveguide portion 112-5 for the second spot size conversion. In the examples of FIG. 5, the second spot size conversion is a change in the spot size of light in the first direction 502 (width). The difference in width between the first and second waveguide portions 108-5, 112-5 at least partly provides the second spot size conversion. In these examples, the second spot size conversion is to increase the spot size in the first direction 502 for light propagating from the second waveguide portion 112-5 to the first waveguide portion 108-5. In these examples, the width of the first waveguide portion 108-5 is not enough to effectively confine, in the first direction 502, the mode of light in question as compared to the second waveguide portion 112-5 with the greater width. Therefore, the mode of light in question expands in the first direction 502 and the spot size in the first direction 502 becomes larger as the mode of light in question passes into the first waveguide portion 108-5.

In the example structures 500, the first waveguide portion is tapered in the second direction. In these examples, the second direction is perpendicular to the first direction 502 and the light propagation direction 116-5. In these examples, a size in the second direction can be referred to as a thickness. In these examples, the first waveguide portion has a thickness taper.

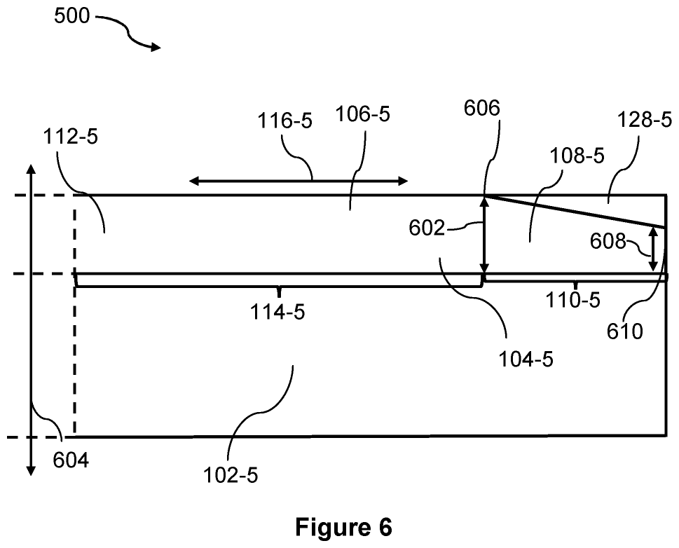

FIG. 6 illustrates schematically a side-cross section of the structure 500 taken along the line C-C in FIG. 5. A size 602 of the first waveguide portion 108-5 in the second direction 604 at a first location 606 along the light propagation direction 116-5 is greater than a size 608 of the first waveguide portion 108-5 in the second direction 604 at a second location 610 along the light propagation direction. The first location 606 is closer to the second waveguide portion 112-5 than the second location 610.

The thickness taper of the first waveguide portion 108-5 at least partly provides the first spot size conversion. In these examples, the first spot size conversion of the light which is a change in the spot size in the second direction 204. In these examples, the first spot size conversion is to increase the spot size in the second direction 604 for light propagating through the first waveguide portion 108-5 away from the second waveguide portion 112-5. While the structure 500 comprises a thickness taper, it is easier to manufacture, e.g. monolithically and does not have waveguide layers at different vertical levels within the structure to provide spot size conversion.

In some examples, there is provided a photonic integrated circuit comprising the semiconductor structure according to any of the examples described above or within the scope of the appended claims. In some such examples, an end of the first waveguide portion is configured for connection with an optical component (e.g. a waveguide) external to the PIC, for coupling light into and/or out of the PIC. In some such examples, the first waveguide portion comprises an input/output end opposite to an end of the first waveguide portion at a position where the first waveguide portion contacts the second waveguide portion.

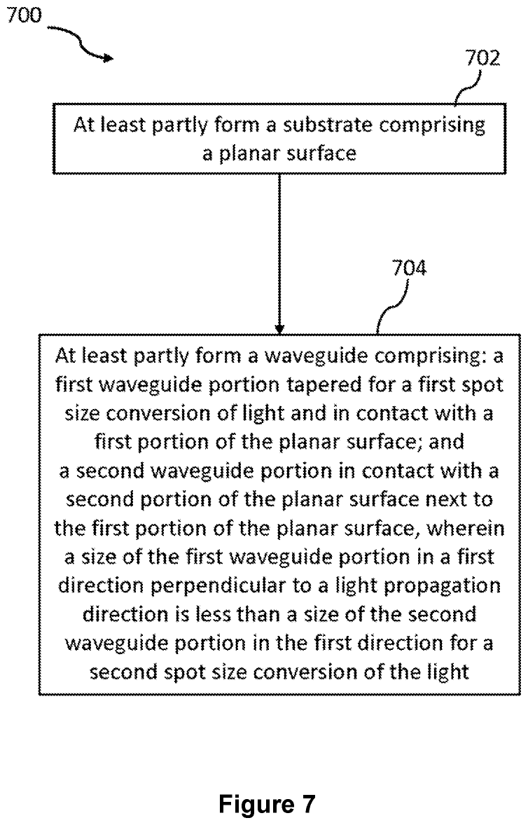

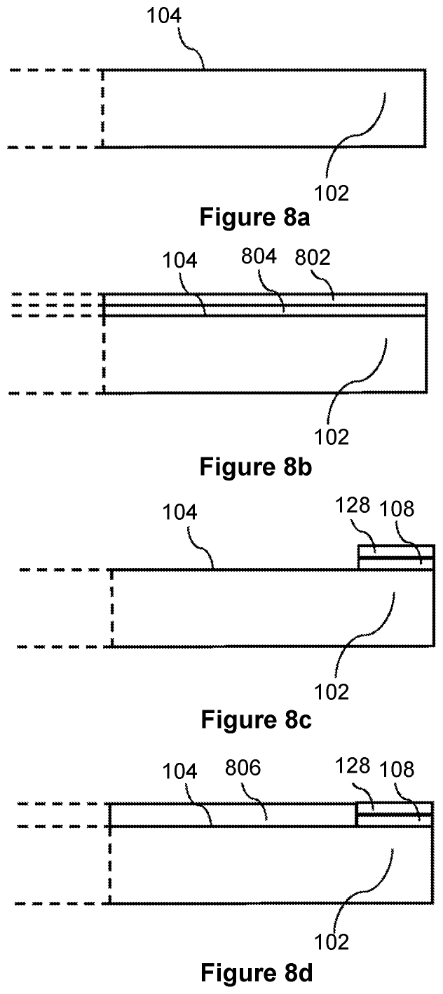

FIG. 7 illustrates part of a method 700 of manufacturing a semiconductor structure (such as any example of the semiconductor structure described above) for a PIC. At block 702 of the method 700, a substrate comprising a planar surface is at least partly formed. FIG. 8a-d illustrate schematically side cross-sections of some examples of a structure obtained from performing some examples of the method 700. FIGS. 8a-d can relate to the examples shown in FIGS. 1-6, however, the reference numerals corresponding to the structure 100 are used for brevity. FIG. 8a illustrates schematically an example substrate (e.g. the substrate 102) resulting from performing block 702.

At block 704 of the method 700, a waveguide is at least partly formed. The waveguide comprises a first waveguide portion tapered for a first spot size conversion of light and in contact with a first portion of the planar surface; and a second waveguide portion in contact with a second portion of the planar surface next to the first portion of the planar surface, wherein a size of the first waveguide portion in a first direction perpendicular to a light propagation direction is less than a size of the second waveguide portion in the first direction for a second spot size conversion of the light.

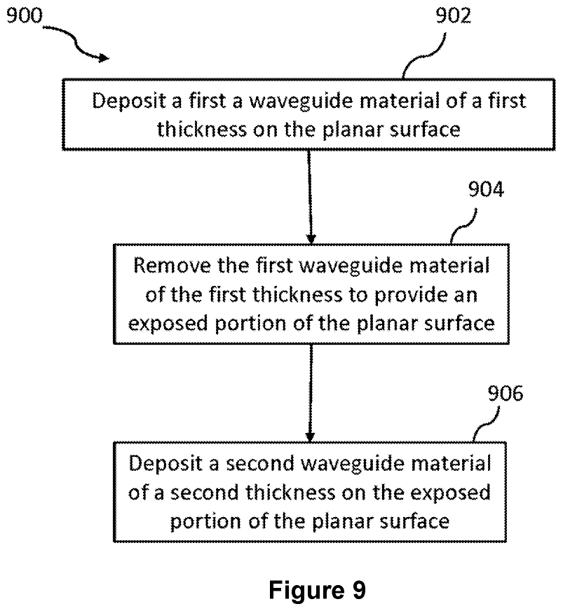

FIG. 9 illustrates a method 900 of at least partly forming the waveguide. The method 900 is, for example, performed as part of block 704 of the method 700. At block 902 of the method 900, a first waveguide material of a first thickness is deposited on the planar surface (e.g. the planar surface 104). For example, the first waveguide material is deposited in a quantity/for an amount of time (depending on the deposition technique) so as to create a layer of the first thickness.

At block 904 of the method 900, the first waveguide material of the first thickness is removed to provide an exposed portion (which includes the second portion) of the planar surface. In some examples of block 904, removing the first waveguide material of the first thickness to provide the exposed portion provides the first waveguide portion of the first waveguide material. For example, the first waveguide material is removed from the planar surface except from the first portion of the planar surface. In some such examples, a mask is placed on the first waveguide material where it is not intended to remove the first waveguide material, and an etching technique is performed to remove the first waveguide material not covered by said mask. For example, the mask is be used to provide the desired shape of the first waveguide portion (e.g. the above described taper, or the shape shown in FIG. 2).

In some such examples, the method 900 comprises depositing a cladding material 802 on the first waveguide material 804 before removing the first waveguide material 804 of the first thickness to provide the exposed portion of the planar surface. For example, the first waveguide material corresponds to the first waveguide portion 108, and the cladding material corresponds to the cladding layer 128 described above. In these examples of block 904, FIG. 8b shows the resulting structure before removal of the first waveguide material 804. In these examples, removing the first waveguide material 804 to provide the exposed portion results in the structure shown in FIG. 8c.

At block 906 of the method 900, a second waveguide material of a second thickness is deposited on the exposed portion of the planar surface. In some examples, the first thickness is different to the second thickness. FIG. 8d shows an example in which the second waveguide material 806 is deposited on the exposed portion.

In examples, the second waveguide material of the second thickness is partly removed to provide the second waveguide portion. For examples, the second waveguide material is removed from either side to e.g. provide the second waveguide portion as shown in FIG. 2, 4 or 5.

In some examples, cladding material is deposited to contact the sides of the first waveguide portion which extend away from the planar surface. Depositing cladding material in this manner, for example provide cladding material as shown in FIG. 2, 4 or 5.

In the examples shown in FIG. 8a-d, the first thickness is different to the second thickness. In some examples, the first thickness is the same as the second thickness and a wet etch procedure is performed to provide the structure shown in FIG. 6.

In the examples described above, the first waveguide material corresponds to the first waveguide portion. In other examples, the first waveguide material corresponds to the second waveguide portion, in that the second waveguide portion comprises the first waveguide material. In these examples, material for the second waveguide portion is deposited before the material for the first waveguide portion. In some such examples (which do not provide a thickness taper), the first thickness is greater than the second thickness.

In these examples, removing the first waveguide material to provide the exposed portion provides the second waveguide portion. When the second waveguide material (for the first waveguide portion in these examples) is deposited, parts of the second waveguide material are subsequently removed to provide the first waveguide portion. In these examples, cladding material of a third thickness is deposited on the second waveguide material, where the second thickness and the third thickness together are substantial the same as the first thickness. This results in the structure shown in FIG. 8d.

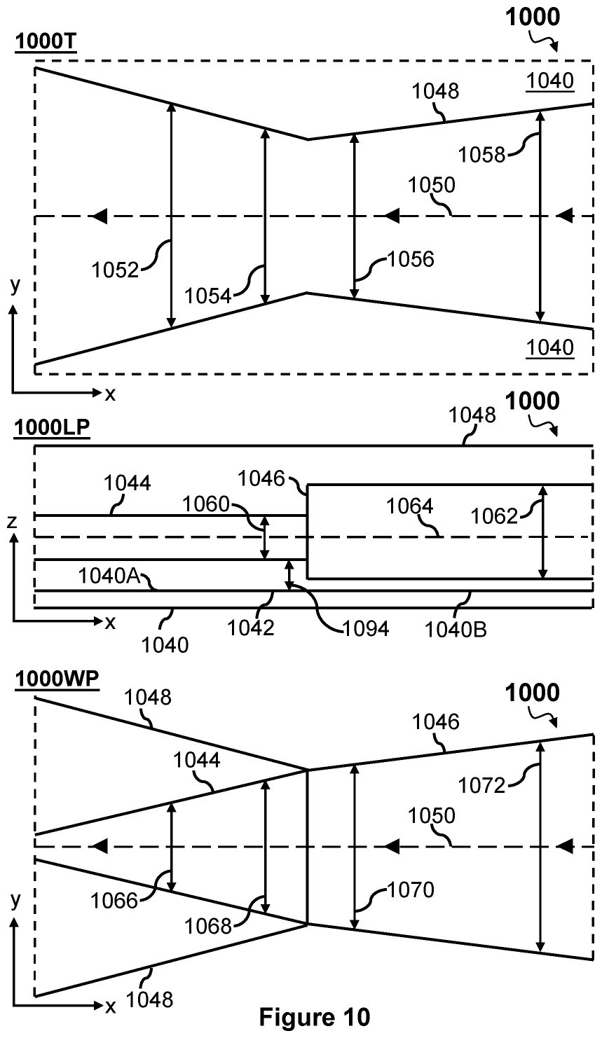

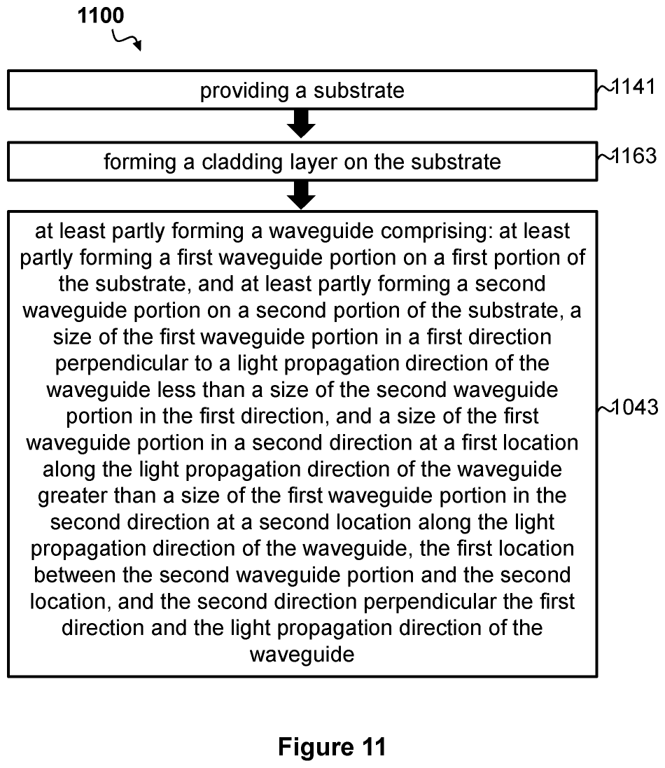

A description of a spot size converter for a PIC and a method of manufacturing a spot size converter for a PIC of further examples herein is now given with reference to FIG. 10 and FIG. 11.

FIG. 10 shows schematically three views of the spot size converter 1000 for a PIC. The relative orientations of each view are indicated using Cartesian x-, y-, and z-axes. The views are: a top plan view (an xy-plane, labelled 1000T); a side cross section (labelled 1000LP) in an xz-plane and at the light propagation direction 1050; and a plan cross-section (labelled 1000WP) in an xy-plane and at a plane 1064 through the waveguide. FIG. 11 is a flow diagram of a method 1100 of manufacturing the spot size converter 1000.

The spot size converter 1000 is, for example, for an increase in spot size in both the first direction z and the second direction y for light propagating from the second waveguide portion 1046 to the first waveguide portion 1044 along the light propagation direction 1050 (direction of propagation indicated by the arrows on the light propagation direction 1050 in FIG. 10). In some examples, a size 1060 of the first waveguide portion in the first direction z being less than a size 1062 of the second waveguide portion 1046 is configured to cause light propagating from the second waveguide portion 1046 to the first waveguide portion 1044 along the light propagation direction 1050 to go from being substantially confined within the second waveguide portion 1046 in the first direction z to being substantially not confined within the first waveguide portion 1044 in the first direction z, resulting in an increase in the spot size in the first direction z and at least part of a spot size conversion. Both the first waveguide portion 1044 and the second waveguide portion 1046 are tapered in the second direction y so that the size of the waveguide portion that light propagating from the second waveguide portion 1046 to the first waveguide portion 1044 along the light propagation direction 1050 propagates through decreases. The tapering of the waveguide portions is, in some examples, configured to cause light propagating from the second waveguide portion 1046 to the first waveguide portion 1044 along the light propagation direction 1050 to go from being substantially confined within the second waveguide portion 1046 in the second direction y to being substantially not confined within the first waveguide portion 1044 in the second direction y, resulting in an increase in the spot size in the second direction y and at least part of the spot size conversion.

A detailed description of features of the spot size converter 1000 of FIG. 10 is now given to elaborate on the summary above.

The spot-size converter 1000 comprises a substrate 1040 and a waveguide. The waveguide comprises a first waveguide portion 1044 and a second waveguide portion 1046. The first waveguide portion 1044 is on a first portion 1040A of the substrate 1040, and the second waveguide portion 1046 is on a second portion 1040B of the substrate 1040. The first waveguide portion 1044 is not in contact with the first portion 1040A of the substrate 1040, and the second waveguide portion 1046 is not in contact with the second portion 1040B of the substrate 1040. In other examples, the first waveguide portion is in contact with the first portion of the substrate 1040, and/or the second waveguide portion is in contact with the second portion of the substrate 1040. A cladding layer 1042 is between the first waveguide portion 1044 and the first portion 1040A of the substrate 1040. The cladding layer is also between the second waveguide portion 1046 and the second portion 1040B of the substrate 1040. In some examples, the cladding layer improves confinement of light in the waveguide when the spot size converter 1200 is in use. In other examples, the cladding layer is not between the first waveguide portion and the first portion of the substrate, and/or not between the second waveguide portion and the second portion of the substrate. In other examples, the spot size converter does not comprise a cladding layer and in some such examples the first waveguide portion and the second waveguide portion are in contact with the substrate. For example, the cladding layer might not be necessary if the light propagating in the waveguide is sufficiently confined within the waveguide. Further, the cladding layer not being present may simplify manufacture of the spot size converter.

As described above, a size 1060 of the first waveguide portion 1044 in a first direction z perpendicular to a light propagation direction 1050 of the waveguide is less than a size 1062 of the second waveguide portion 1046 in the first direction z. Further, a size 1068 of the first waveguide portion 1044 in a second direction y at a first location along the light propagation direction 1050 of the waveguide is greater than a size 1066 of the first waveguide portion 1044 in the second direction y at a second location along the light propagation direction 1050 of the waveguide. The first location is between the second waveguide portion 1046 and the second location. The second direction y is perpendicular to the first direction z and the light propagation direction 1050 of the waveguide. The first waveguide portion 1044 is tapered in the second direction y for a spot size conversion, e.g., at least one of the first spot size conversion or the second spot size conversion. The taper of the first waveguide portion 1044 is at a constant rate. In some examples, such a constant rate of taper reduces scattering and/or improves the efficiency of the spot size conversion when the spot size converter 1000 is in use. In other examples, the taper of the first waveguide portion is not at a constant rate, e.g., the taper is stepped, or parabolic. A size 1070 of the second waveguide portion 1046 in the second direction y at a third location along the light propagation direction 1050 is less than a size 1072 of the second waveguide portion 1046 in the second direction y at a fourth location along the light propagation direction 1050. The third location is closer to the first waveguide portion 1044 than the fourth location. The second waveguide portion 1046 is tapered in the second direction y for a spot size conversion, e.g., at least one of the first spot size conversion or the second spot size conversion. The taper of the second waveguide portion 1046 is at a constant rate. In some examples, such a constant rate of taper reduces scattering and/or improves the efficiency of the spot size conversion when the spot size converter 1000 is in use. In other examples, the taper of the second waveguide portion is not at a constant rate, e.g., the taper is stepped, or parabolic.

The first waveguide portion 1044 is spaced from the substrate 1040. A distance 1094 in the first direction z between the substrate 1040 and the first waveguide portion 1044 is less than the size 1062 of the second waveguide portion 1046 in the first direction z. In some such examples, this improves the symmetry of the spot size conversion, reduces scattering, and/or improves the confinement of light in the waveguide when the spot size converter is in use.

The size 1060 of the first waveguide portion 1044 in the first direction z is less than the size 1062 of the second waveguide portion 1046 in the first direction z such that a surface of the first waveguide portion 1044 is stepped relative to a surface of the second waveguide portion 1046. In some examples, the surface the first waveguide portion 1044 being stepped relative to the surface of the second waveguide portion 1046 simplifies manufacture of the spot size converter 1200 compared to a slope. Further, the surface the first waveguide portion 1044 being stepped relative to the surface of the second waveguide portion 1046 may reduce the confinement of light propagating in the first waveguide portion 1044, resulting in a greater change in spot size when the spot size converter 1000 is in use. The surface of the first waveguide portion 1044 is next to the surface of the second waveguide portion 1046. In other examples, the surface of the first waveguide portion is not stepped relative to the surface of the second waveguide portion. This difference in the size 1060 of the first waveguide portion 1044 in the first direction z and the size of the second waveguide portion 1046 in the first direction z is for a spot size conversion, e.g., at least one of the first spot size conversion or the second spot size conversion.

The first direction z is substantially perpendicular to a surface of the substrate 1040. In other examples, the first direction is substantially parallel to a surface of the substrate. The second direction y is substantially parallel to the surface of the substrate. In other examples, the second direction y is substantially perpendicular to a surface of the substrate.

In other examples, a size of the second waveguide portion in a second direction at a third location along the light propagation direction is greater than the size of the second waveguide portion in the second direction at a fourth location along the light propagation direction, the third location closer to the first waveguide portion than the fourth location, and the second direction is perpendicular the first direction and the light propagation direction of the waveguide.

The waveguide comprises cladding material. In some examples the cladding material comprises at least one of: a semiconductor, a dielectric, a polymer, a fluid, a gas, air, or a vacuum. The cladding material comprises the cladding layer 1042 and top cladding 1048, and is in contact with the first waveguide portion 1042 and the second waveguide portion 1046. Other configurations of the cladding material are envisaged.

The waveguide comprises a top cladding 1048 on the first waveguide portion 1044 and the second waveguide portion 1046. The top cladding 1048 is in contact with the first waveguide portion 1044 and the second waveguide portion 1046. In other examples, the top cladding is not in contact with the first waveguide portion and the second waveguide portion.

A size 1054 of the top cladding 1048 in the second direction y at the first location along the light propagation direction 1050 of the waveguide is less than a size 1052 of the top cladding 1048 in the second direction y at a second location along the light propagation direction 1050 of the waveguide. A size 1056 of the top cladding 1048 in the second direction y at the third location along the light propagation direction 1050 is less than a size 1058 of the top cladding 1048 in the second direction y at a fourth location along the light propagation direction 1050. The top cladding 1048 has two tapers in the second direction y, each for a respective spot size conversion. The tapers of the top cladding 1048 are each respectively at a constant rate. In some examples, constant rates of taper reduce scattering and/or improve the efficiency of the spot size conversion when the spot size converter 1000 is in use. In other examples, at least one of the tapers of the top cladding are not at a constant rate, e.g., the tapers are stepped, or parabolic.

The method 1100 of manufacturing the spot size converter 1000 for a PIC comprises providing 1141 a substrate 1040, then forming 1163 a cladding layer 1042 on the substrate 1040. The method 1100 then comprises at least partly forming 1043 a waveguide comprising the first waveguide portion 1044 and the second waveguide portion 1046 as described above in relation to FIG. 10. Other methods of manufacturing the spot size converter 1000 are envisaged.

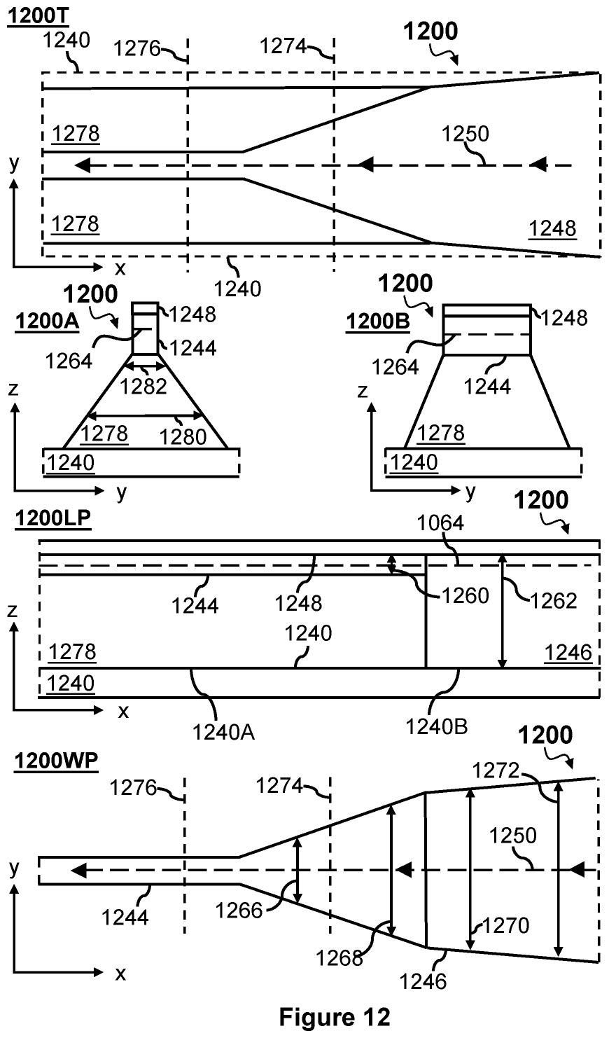

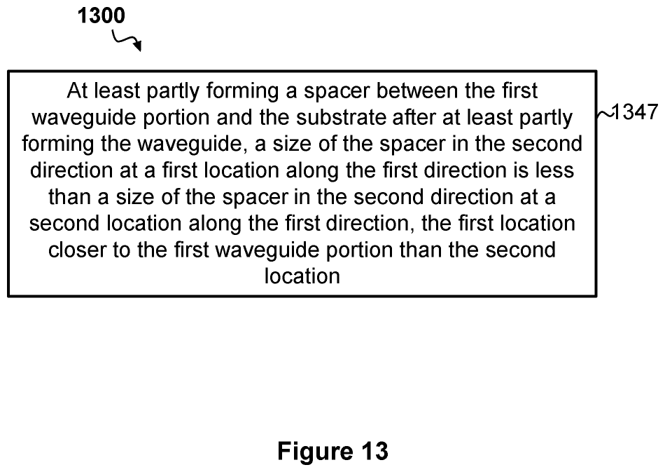

A description of a spot size converter for a PIC and a method of manufacturing a spot size converter for a PIC of further examples herein is now given with reference to FIG. 12 and FIG. 13.

FIG. 12 shows schematically five views of the spot size converter 1200. The relative orientations of each view are indicated using Cartesian x-, y-, and z-axes. The views are: a top plan view (an xy-plane, labelled 1200T); a side cross section (labelled 1200LP) in an xz-plane, the light propagation direction 1250 on the xz-plane of the side cross-section; a plan cross-section (labelled 1200WP) in an xy-plane; a side cross section (labelled 1200A) in an yz-plane, a plane 1276 on the yz-plane; and a side cross section (labelled 1200B) in an zy-plane, a plane 1274 on the yz-plane. FIG. 13 is a flow diagram of the method 1300 of manufacturing the spot size converter 1200.

Where a feature in relation to FIG. 12 corresponds with a feature described using FIG. 10 a reference numeral is used which is 200 greater than the corresponding reference numeral used for FIG. 10 (e.g., 1040 in FIG. 10 is 1240 in FIG. 12); corresponding descriptions for such features apply here also.

Similarly to the spot size converter 1000 of FIG. 10, the spot size converter 1200 of FIG. 12 is configured for a spot size conversion increasing the spot size in the first direction z and the second direction y of light propagating along the light propagation axis 1250 from the second waveguide portion 1246 to the first waveguide portion 1244. Contrastingly to the examples of FIG. 10, the examples of FIGS. 12 and 13 comprise a spacer 1278 between the first waveguide portion 1244 and the substrate 1240. The spacer 1278 is tapered in the second direction z. In some examples, the tapering of the spacer 1278 improves the mechanical stability of the spot size converter 1200, and the manufacturing tolerances when manufacturing the spot size converter 1200.

A detailed description of features of the spot size converter 1200 of FIG. 12 is now given.

The spot-size converter 1200 comprises a substrate 1240 and a waveguide. The waveguide comprises a first waveguide portion 1244 and a second waveguide portion 1246. The first waveguide portion 1244 is on a first portion 1240A of the substrate 1240 and the second waveguide portion 1246 is on a second portion 1240B of the substrate 1240. A size 1260 of the first waveguide portion 1244 in a first direction z perpendicular to a light propagation direction 1250 of the waveguide is less than a size 1262 of the second waveguide portion 1246 in the first direction z. A size 1268 of the first waveguide portion 1244 in a second direction y at a first location along the light propagation direction 1250 of the waveguide is greater than a size 1266 of the first waveguide portion 1244 in the second direction y at a second location along the light propagation direction 1250 of the waveguide. The first location is between the second waveguide portion 1246 and the second location. The second direction y is perpendicular to the first direction z and the light propagation direction 1250 of the waveguide. The first waveguide portion 1244 has a tapered part and a non-tapered part, in other examples it is envisaged that the first waveguide portion is tapered along its entire length.

A size 1270 of the second waveguide portion 1246 in a second direction y at a third location along the light propagation direction 1250 is less than a size 1272 of the second waveguide portion 1246 in the second direction y at a fourth location along the light propagation direction 1250, the third location closer to the first waveguide portion 1244 than the fourth location. The first waveguide portion 1244 is spaced from the substrate 1240. A distance 1294 in the first direction z between the substrate 1240 and the first waveguide portion 1244 is less than the size 1262 of the second waveguide portion 1246 in the first direction z.

In contrast to FIG. 10, the spot size converter 1200 of FIG. 12 comprises a spacer 1278 between the first waveguide portion 1244 and the substrate 1240. In some examples, the spacer 1278 is InP and is formed by epitaxy, although other spacers are envisaged. A size 1282 of the spacer 1278 in the second direction y at a first location along the first direction z is less than a size 1280 of the spacer 1278 in the second direction y at a second location along the first direction z. The first location is closer to the first waveguide portion 1244 than the second location. The spacer is tapered. In other examples, other configurations and forms of the spacer are envisaged, such as a non-tapered spacer. The spacer 1278 is tapered in the second direction y, e.g., for improved mechanical strength of the spot size converter 1200. The rate of the taper of the spacer 1278 is constant at a single plane perpendicular to the light propagation direction 1250 such as at either of planes 1276 or 1274. The rate of taper of the spacer 1278 is different at different planes perpendicular to the light propagation direction 1250, e.g., the rate of taper of the spacer 1278 at planes 1276 is different to that at plane 1274. The rate of taper of the spacer 1278 is, e.g., chosen at different points along the light propagation direction 1250 to meet the mechanical requirements for the spot size converter 1200 (a greater rate of taper improves mechanical performance) and the size requirements for the spot size converter (a greater rate of taper increases the size of the spot size converter). Other taper configurations are envisaged such as stepped or parabolic tapers. The spacer 1278 has the function of a cladding layer of the waveguide; however, in other examples, the spacer does not have the function of a cladding layer.

In examples the method 1300 of manufacturing a spot size converter 1300 may, for example, be preceded at least by providing 1141 a substrate as previously described in relation to FIGS. 10 and 11. The method 1300 comprises at least partly forming 1347 a spacer 1278 between the first waveguide portion 1244 and the substrate 1240 after at least partly forming the waveguide (which may be at least partly formed 1043 as described in relation to FIG. 10 and FIG. 11), a size 1282 of the spacer 1278 in the second direction y at a first location along the first direction z is less than a size 1280 of the spacer 1278 in the second direction y at a second location along the first direction z, the first location closer to the first waveguide portion 1244 than the second location.

In some examples at least partly forming 1347 the spacer 1278 comprises wet etching. Wet etching, e.g., allows the formation surface of the spacer 1278 that is not parallel to the first direction z, allowing formation of the spacer 1278 with a taper in the second direction y. Other methods of forming the spacer 1278 with the taper in the second direction y are envisaged, for example, at least partly forming the spacer comprising lithography or dry etching.

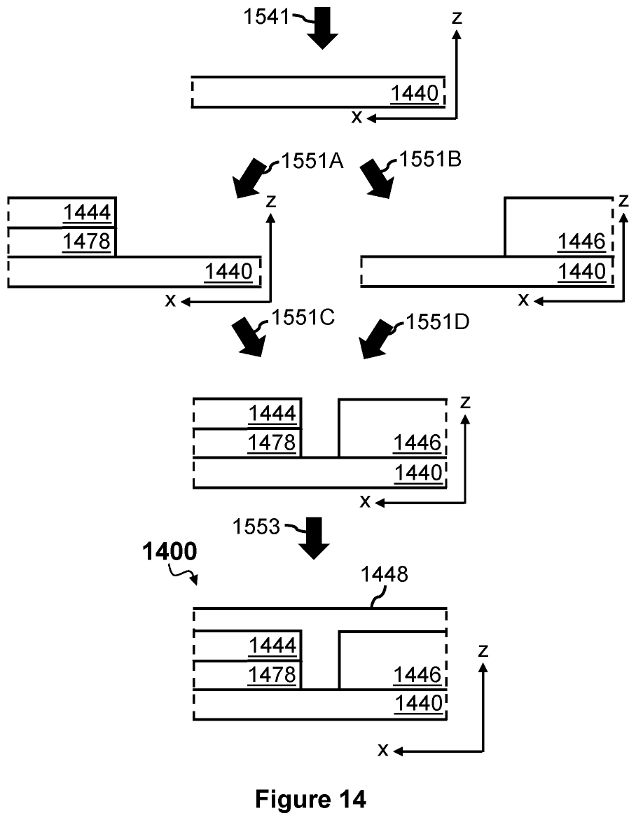

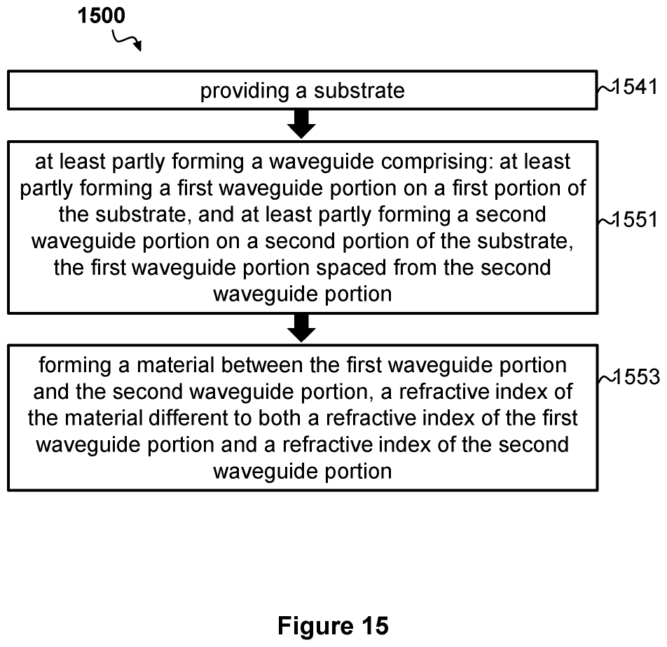

A description of a spot size converter and a method of manufacturing a spot size converter of further examples herein is now given with reference to FIG. 14 and FIG. 15.

FIG. 14 schematically shows side cross-sections of the spot size converter during the method of FIG. 15. The relative orientations of each view are indicated using Cartesian x-, y-, and z-axes. FIG. 15 is a flow diagram of the method 1500 of manufacturing the spot size converter 1400.

Where a feature in relation to FIG. 14 corresponds with a feature described using FIG. 10 a reference numeral is used which is 400 greater than the corresponding reference numeral used for FIG. 10 (e.g., 1040 in FIG. 10 is 1440 in FIG. 14); corresponding descriptions for such features apply here also.

Similarly to the examples above, the spot size converter 1400 is, for example, for an increase in spot size in both the first direction z and the second direction (perpendicular to both the first direction z and the third direction x) for light propagating from the second waveguide portion 1446 to the first waveguide portion 1444. In the examples of FIGS. 14 and 15, the spot size converter 1400 comprises a material 1448 between the first waveguide portion 1444 and the second waveguide portion 1446. A refractive index of the material 1448 is different to a refractive index of the second waveguide portion 1446. In some such examples, when the spot size converter 1400 is in use, light propagating from the second waveguide portion 1446 into the material 1448 is scattered at an interface between the second waveguide portion 1446 and the material 1448, resulting in an increase in the spot size of the light in at least one of the first direction z and the second direction x.

A detailed description of features of the spot size converter 1400 of FIG. 14 and the method 1500 of manufacturing the spot size converter 1400 is now given to elaborate on the summary above.

The method 1500 of manufacturing a spot size converter 1400 comprises providing 1541 a substrate 1440. Then the method 1500 comprises at least partly forming 1551 a waveguide. In FIG. 14 this is split into two examples. In the first example 1551A and 1551C, at least partly forming the waveguide comprises at least partly forming 1551A a first waveguide portion 1448 and a spacer 1478 on a first portion of the substrate 1440. The spacer 1478 is between the first waveguide portion 1444 and the substrate 1440. Then the first example comprises at least partly forming 1551C a second waveguide portion 1446 on a second portion of the substrate 1440. The first waveguide portion 1444 spaced from the second waveguide portion 1446. In the second example 1551B and 1551C, at least partly forming the waveguide comprises at least partly forming 1551B a second waveguide portion 1446 on a second portion of the substrate 1440. Then the second example comprises at least partly forming 1551D a first waveguide portion 1448 and a spacer 1478 on a first portion of the substrate 1440. The spacer 1478 is between the first waveguide portion 1444 and the substrate 1440.

The method 1500 then comprises forming 1553 a material 1448 between the first waveguide portion 1444 and the second waveguide portion 1446. The material 1448 is, for example, InGaAsP and may be formed by epitaxy. A refractive index of the material 1448 is different to both a refractive index of the first waveguide portion 1444 and a refractive index of the second waveguide portion 1446. In some examples, the material 1448 is a spacer and/or top cladding.

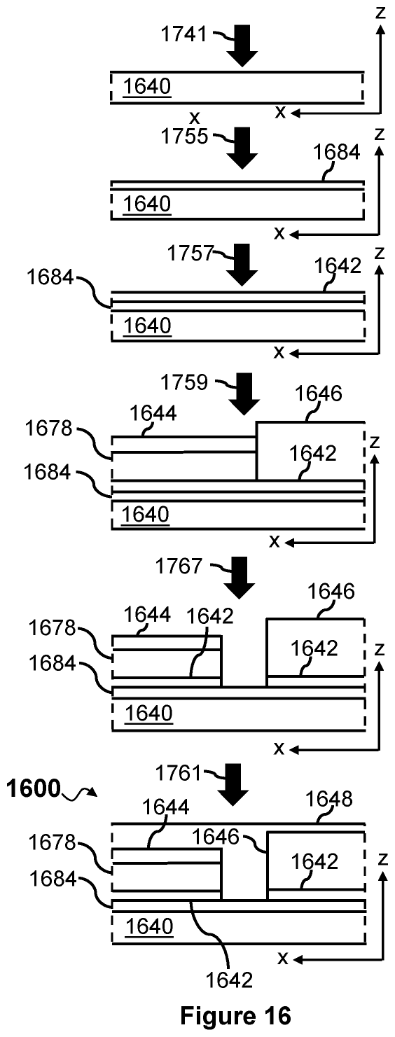

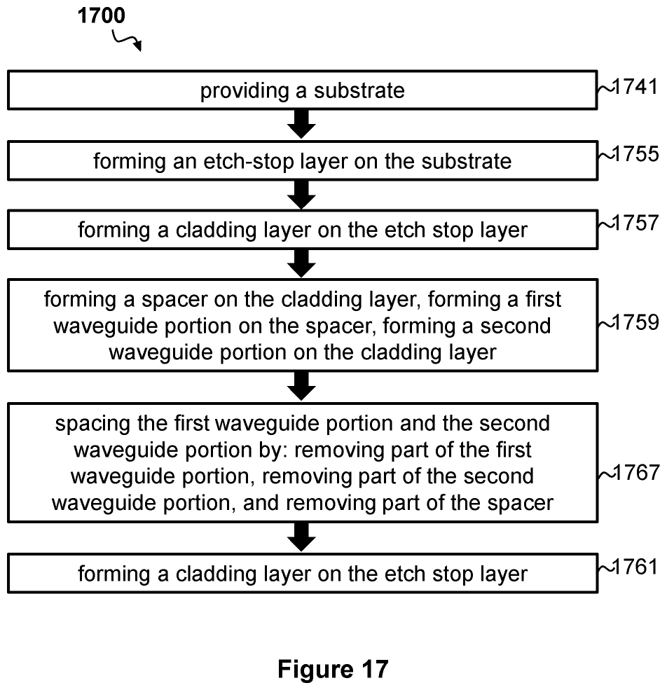

A description of a spot size converter for a PIC and a method 1700 of manufacturing a spot size converter 1600 for a PIC of further examples herein is now given with reference to FIG. 16 and FIG. 17.

FIG. 16 shows schematically shows side cross-sections of the spot size converter during the method of FIG. 17. The relative orientations of each view are indicated using Cartesian x-, y-, and z-axes. FIG. 17 is a flow diagram of the method 1700 of manufacturing the spot size converter 1600.

Where a feature in relation to FIG. 16 corresponds with a feature described using FIG. 10 a reference numeral is used which is 600 greater than the corresponding reference numeral used for FIG. 10 (e.g., 1040 in FIG. 10 is 1640 in FIG. 16); corresponding descriptions for such features apply here also.

Similarly to the examples of FIGS. 14 and 15 above, the spot size converter 1600 is, for example, for an increase spot size in both the first direction z and the second direction (perpendicular to both the first direction z and the third direction x) for light propagating from the second waveguide portion 1646 to the first waveguide portion 1644. Further, the spot size converter 1600 comprises a material 1648 between the first waveguide portion 1644 and the second waveguide portion 1646. A refractive index of the material 1648 is different to a refractive index of the second waveguide portion 1646. In some such examples light propagating from the second waveguide portion 1646 into the material 1648 is scattered at the interface between the second waveguide portion 1646 and the material 1648 and the scattering results in an increase in the spot size of the light in at least one of the first direction and the second direction x. In contrast to the examples of FIGS. 14 and 15, in the examples of FIGS. 16 and 17 the method 1700 comprises spacing 1767 the first waveguide portion 1644 and the second waveguide portion 1646 by: removing part of the first waveguide portion 1644, removing part of the second waveguide portion 1646, and removing part of the spacer 1678. Some such examples allow precise control of the spacing between the first waveguide portion 1644 and the second waveguide portion 1646, and therefore control over scattering that may occur between the first waveguide portion 1644 and the second waveguide portion 1646 when the spot size converter 1600 is in use. Further, the examples of FIGS. 16 and 17 comprise an etch-stop layer 1684 on the substrate 1640. In some examples, the etch-stop layer 1684 prevents or reduces removal of the substrate 1640 e.g., by etching, during spacing 1767 of the first waveguide portion 1644 and the second waveguide portion 1646.

A detailed description of features of the spot size converter 1600 of FIG. 16 and the method 1700 of manufacturing the spot size converter 1600 is now given to elaborate on the summary above.

The method 1700 comprises providing 1741 a substrate 1640. Then the method 1700 comprises forming 1755 an etch-stop layer 1684 on the substrate 1640. Next, the method 1700 comprises forming 1757 a cladding layer 1642 of cladding material on the etch-stop layer 1684. Then, the method 1700 comprises: forming 1759 a spacer 1678 on the cladding layer 1642, forming 1759 a first waveguide portion 1644 of a first waveguide material on the spacer 1678, and forming 1759 a second waveguide portion 1646 of a second waveguide material on the cladding layer 1642. Then, the method 1700 comprises spacing 1767 the first waveguide portion 1644 and the second waveguide portion 1646 by: removing part of the first waveguide portion 1644, removing part of the second waveguide portion 1646, and removing part of the spacer 1678. Next, the method 1700 comprises forming 1761 a cladding layer 1648 on the etch stop layer 1684.

In other examples, at least partly forming the waveguide comprises: depositing a first waveguide material of a first thickness on the substrate. Then at least part of the first waveguide material of the first thickness is removed to provide: an exposed portion of the substrate, the first waveguide portion, and the second waveguide portion. In other examples, spacing the first waveguide portion and the second waveguide portion comprises at least one of: removing part of the first waveguide portion, removing part of the second waveguide portion, etching part of the first waveguide portion, etching part of the second waveguide portion, or lithography of part of the first waveguide portion, or lithography of part of the second waveguide portion. Other methods of separating the first waveguide portion and the second waveguide portion are envisaged.

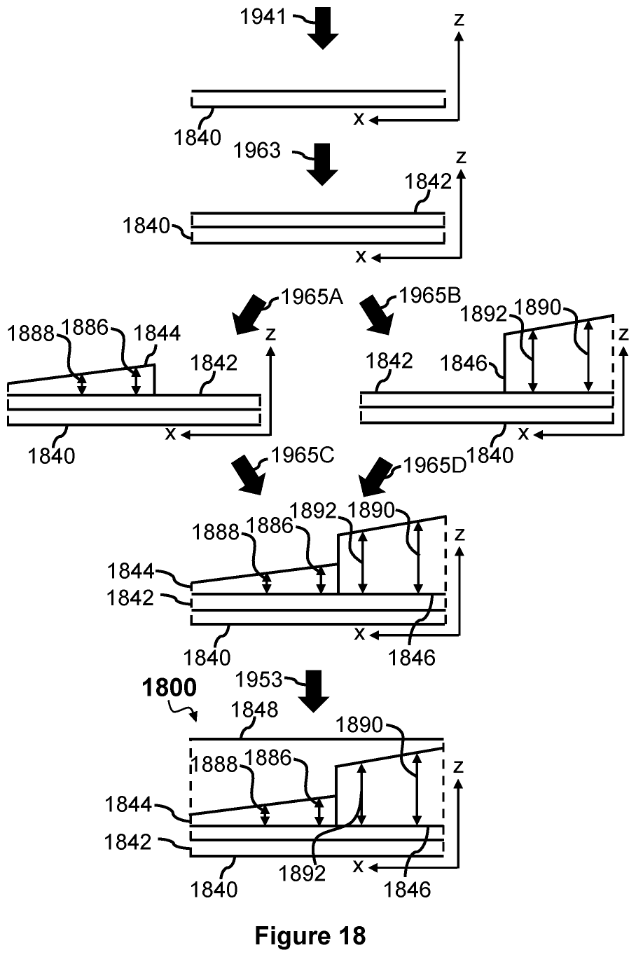

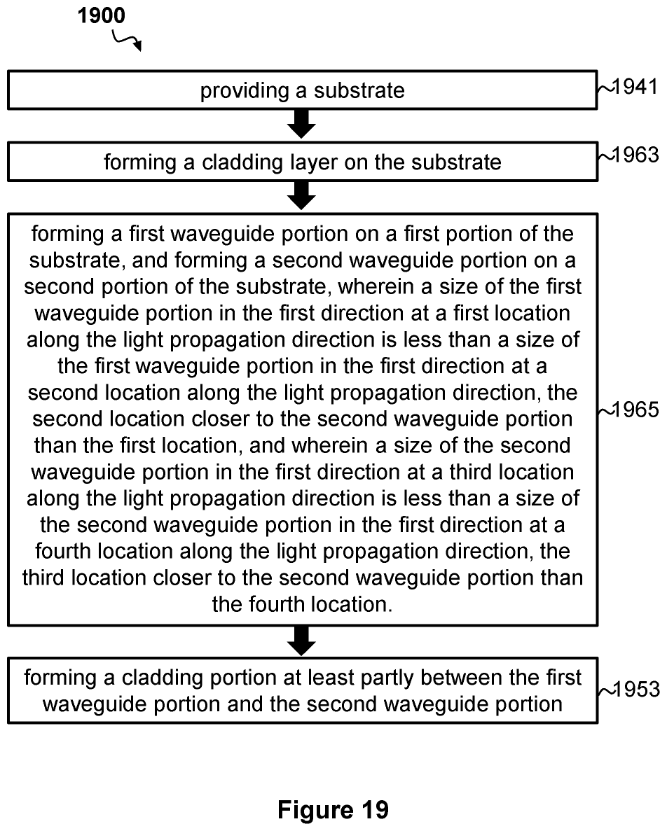

A description of a spot size converter and a method of manufacturing a spot size converter of further examples herein is now given with reference to FIG. 18 and FIG. 19.

FIG. 18 schematically shows side cross-sections of the spot size converter during the method of FIG. 19. The relative orientations of each view are indicated using Cartesian x-, y-, and z-axes. FIG. 19 is a flow diagram of the method 1900 of manufacturing the spot size converter 1800. Where a feature in relation to FIG. 18 corresponds with a feature described using FIG. 10 a reference numeral is used which is 800 greater than the corresponding reference numeral used for FIG. 10 (e.g., 1040 in FIG. 10 is 1840 in FIG. 18); corresponding descriptions for such features apply here also.

The spot size converter 1800 is, for example, for an increase in spot size in at least the first direction z for light propagating from the second waveguide portion 1846 to the first waveguide portion 1844. The first waveguide portion 1844 and the second waveguide portion 1846 are each tapered in the first direction z. When the spot size converter 1800 is in use, in some examples, the tapers of the first waveguide portion 1844 and the second waveguide portion 1846 cause light propagating from the second waveguide portion 1846 to the first waveguide portion 1844 along the light propagation direction (parallel to x) to go from being substantially confined within the second waveguide portion 1846 in the first direction z to being substantially not confined within the first waveguide portion 1844 in the first direction z, resulting in an increase in the spot size in the first direction z and at least part of a spot size conversion. The tapering of the first waveguide portion 1844 and the second waveguide portion 1846 in the first direction z, in some examples, reduces scattering and/or improves the efficiency of the spot size conversion when the spot size converter 1800 is in use.

A detailed description of features of the spot size converter 1800 of FIG. 18 and the method 1900 of manufacturing the spot size converter 1800 is now given to elaborate on the summary above.

The method 1900 comprises providing 1941 a substrate 1840. Then, the method 1900 comprises forming 1963 a cladding layer 1842 on the substrate 1840. Next, the method 1900 comprises forming 1965 a first waveguide portion 1844 on a first portion of the substrate 1840, and a second waveguide portion 1846 on a second portion of the substrate 1840. A first example 1965A and 1965C of forming the first waveguide portion 1844 and the second waveguide portion 1846 comprises first forming 1965A the first waveguide portion 1844, then forming 1965C the second waveguide portion 1846. A second example 1965B and 1965D of forming the first waveguide portion 1844 and the second waveguide portion 1846 comprises first forming 1965A the second waveguide portion 1846, then forming 1965D the first waveguide portion 1844. In other examples the first waveguide portion and the second waveguide portion are formed simultaneously, or a waveguide precursor is formed (e.g., by epitaxy) and then the first waveguide portion and the second waveguide portion are formed from the waveguide precursor (e.g., by lithography and/or etching). A size 1888 of the first waveguide portion 1844 in the first direction z at a first location along the light propagation direction (parallel to x) is less than a size 1886 of the first waveguide portion 1844 in the first direction z at a second location along the light propagation direction (parallel to x). The second location is closer to the second waveguide portion 1886 than the first location. A size 1892 of the second waveguide portion 1846 in the first direction z at a third location along the light propagation direction (parallel to x) is less than a size 1890 of the second waveguide portion 1846 in the first direction z at a fourth location along the light propagation direction (parallel to x). The third location is closer to the second waveguide portion 1846 than the fourth location. Then, the method 1900 comprises forming 1953 a cladding portion at least partly between the first waveguide portion and the second waveguide portion. In other examples, the method does not comprise forming a cladding portion, e.g., because the fluid surrounding the first waveguide portion and the second waveguide portion acts as cladding.

A description of some terms and features used previously is now given, to elaborate on features of examples described herein.

In some examples, the spot size converter is at least one of: for a PIC, or part of a PIC. In some examples the spot size converter is configured for a first spot-size conversion and a second spot-size conversion.

In some such examples the first spot size conversion at least one of: greater in magnitude than a second spot-size conversion, lesser in magnitude than the second spot-size conversion, or substantially equal in magnitude to the second spot-size conversion. In some examples, the first spot-size conversion is an increase of spot-size in the second direction for light propagating through the first waveguide portion away from the second waveguide portion, and the second direction is perpendicular the first direction and the light propagation direction of the waveguide. In some examples, the second spot-size conversion is an increase of spot-size in the first direction for light propagating from the second waveguide portion to the first waveguide portion.

A method herein can be performed where material for the second waveguide portion is deposited before material for the first waveguide portion, the first thickness is the same as the second thickness, and a wet etch procedure is performed to provide a thickness taper for the first waveguide portion.

In the above description, reference is made to at least partly forming layers and the like. In some examples, a layer referred to in this manner is simply formed by depositing the relevant material, without requiring further steps. In other examples, further steps are performed to complete the formation of a layer (for example, a curing step, an etching step to define the extent of a layer, etc.). In some examples, the further steps to complete the formation of a layer are performed before further material is deposited on top of the layer in question. In other examples, the further steps to complete the formation of a layer are performed after further material is deposited on top of the layer in question.

In some examples forming herein comprises a manufacture process, e.g., using known techniques such as: epitaxy, chemical vapour deposition techniques, vapour phase epitaxy (VPE), metalorganic vapour-phase epitaxy (MOVPE) surface passivation, lithography, photolithography, ion implantation, etching, dry etching ion etching, wet etching, buffered oxide etching, plasma ashing, plasma etching, thermal treatment, annealing, thermal oxidation, chemical vapor deposition, atomic layer deposition, physical vapor deposition, molecular beam epitaxy (MBE), laser lift-off, electrochemical deposition, electroplating, chemical-mechanical polishing, wafer fusion, anodic bonding, or adhesion. Etching techniques (for example, using patterned masks) may be used to remove material in accordance with described examples.

A waveguide herein is for guiding light; when a waveguide is in use light propagates along the waveguide. A waveguide comprises a core and cladding at least partly in contact with the core. In some examples, the cladding is a least one of: a solid, a fluid, gas, air, or a vacuum. Properties of a waveguide including, for example: a boundary of the waveguide, a boundary between the core and the cladding, the refractive index of the core, the refractive index of the cladding, and/or the structure of the waveguide to at least partly confine light propagating along the waveguide to within the waveguide. For example, light propagating along the waveguide might be predominantly within the core. In some examples, the boundary between the core and the cladding can be thought of as resulting in constructive interference of light which confines light to propagate substantially within the core. An evanescent field may exist in the cladding when light is guided by the waveguide. The cladding may comprise a solid structure; however, in some examples the cladding comprises gas, liquid, and/or a vacuum in contact with the core. The core may have a greater refractive index than the cladding for the wavelengths of light guided by the waveguide. In some examples, the cladding comprises a plurality of portions, e.g., with different refractive indices. Examples of such cladding include step-index cladding and graded-index cladding. In some examples the waveguide comprises a plurality of cores; such waveguides may be referred to as multi-core waveguides. In some examples, the first waveguide portion and the second waveguide portion are of the same material. In other examples, the first waveguide portion is of a material different to a material of the second waveguide portion. In some examples, the first waveguide portion is a first portion of the core of the waveguide, and/or the second waveguide portion is a second portion of the core of the waveguide.

When the waveguide herein is in use, light propagates along the waveguide in the light propagation direction. The light propagation direction is parallel to the Poynting vector of light propagating along the waveguide. The light propagation direction is the general direction which the energy of the light mode propagates along the waveguide.

In some examples, an end of the first waveguide portion and/or an end of the second waveguide portion is configured for at least one of: connection with a waveguide external to the photonic integrated circuit; coupling light into the photonic integrated circuit; or coupling light out of the photonic integrated circuit.

Herein, the core comprises the first waveguide portion and the second waveguide portion.

The first waveguide portion is of a first waveguide material, and the second waveguide portion is of a second waveguide material. The first waveguide material may be the same as the second waveguide material or different to the second waveguide material. The first waveguide portion may at least partly be provided by removing a portion of first waveguide material. The second waveguide portion may at least partly be provided by removing a portion of the second waveguide material. The second waveguide portion may comprises the first waveguide material and/or the first waveguide portion may comprise the first waveguide material.

Cladding herein may comprise the cladding portion, cladding material, the cladding layer, and/or the substrate herein. In some examples the cladding, cladding portion and/or cladding layer increases the confinement of light in the waveguide and/or reduces losses of light from the waveguide. In some examples the cladding reduces the scattering and absorption losses of the waveguide, and/or reduces coupling of undesired light from external sources into the waveguide. Forming cladding, a cladding portion, and/or cladding layer herein may be by epitaxy. It is envisaged that cladding, a cladding portion, and/or cladding layer may comprise several steps. Cladding and/or a cladding material may comprise a plurality of portions, e.g., top cladding and bottom cladding. The top cladding and bottom cladding may comprise the same material and/or have the same refractive index. In other examples the top cladding is different to the bottom cladding.

The cladding may contact the sides of the first waveguide portion which extend away from the substrate and/or the sides of the second waveguide portion which extend away from the substrate.

Cladding herein may comprise at least one of: a semiconductor, a III-V semiconductor, a polymer, a dielectric, silicon (Si), gallium (Ga), germanium (Gr), lithium niobate (LiNbO₃), graphene (C), indium (In), or an alloy, oxide, nitride, or phosphide of at least one of such. Other examples of cladding may comprise at least one of: glass, plastic, metal, or air. Other cladding materials are envisaged.

In some examples, a first refractive index of the cladding material may be between 0.05 and 0.3. In some examples the first refractive index of the cladding material is less than at least one of: a second refractive index of the first waveguide portion, or a third refractive index of the second waveguide portion. In other examples, the first refractive index of the cladding material is greater than at least one of: the second refractive index of the first waveguide portion, or the third refractive index of the second waveguide portion.

In some examples the substrate, when in use, has the function of a cladding layer.

An optical connection is such that light propagates between the optically connected elements. The optically connected optical elements are, for example, configured such that light may propagate through free space between the optically connected optical elements and/or the optically connected optical elements are connected by a waveguide such that light may propagate through the waveguide between the optically connected optical elements. As the skilled person will appreciate, optical as used herein refers to at least one of ultraviolet, visible, mid-infrared, infrared C-band, or infrared light.

A PIC herein integrates a plurality of photonic functions, for example any of a semiconductor optical amplifier, an electro-optical modulator, an interferometer, a Mach-Zehnder interferometer, a grating, a laser or a photodiode, though other photonic functions are envisaged. In some examples, a PIC is configured for use with at least one of ultraviolet light, visible light, or infrared light. Optical radiation e.g. includes at least one of ultraviolet light, visible light, or infrared light. In some examples, a PIC comprises an electrical circuit. PICs may be used for communications devices, biomedical devices, and photonic computing, but other applications are envisaged.

In some examples, the spot size converter is part of a PIC. Some examples relate to a PIC comprising the spot size converter described herein.

A substrate may also be referred to as a chip, a slice, a wafer, or a layer. A substrate is, e.g., a generally planar or relatively thin portion of material, and in some examples is crystalline. A substrate may be a disc or part of a disc of crystalline Si for use in a semiconductor fabrication plant, and in some such examples is a 125 gram, 300 millimetre diameter disc. A substrate may alternatively be a disc or part of a disc of crystalline InP for use in a semiconductor fabrication plant, and in some such examples is a 25 millimetre, 51 millimetre, 76 millimetre, 100 millimetre, 200 millimetre or 300 millimetre diameter disc. A substrate referred to herein is, for example, a single layer of the same homogenous material, though it is envisaged for other examples that a substrate instead comprises one or more layers or portions each deposited or formed independently of each other (for example one after another during a manufacture process to form a stack of sub-layers which together could be considered a substrate). In some examples, a substrate comprises portions of different materials, for example, for fabrication. Providing the substrate may comprise forming the substrate, e.g. by epitaxy; however, it is envisaged that the substrate may be formed by a separate method not described herein. Further, providing the substrate may comprise several steps. The substrate, the first waveguide portion and/or the second waveguide portion may be monolithically integrated into the spot size converter.

In some examples, the substrate herein is a semiconductor, a III-V semiconductor, a polymer, and/or a dielectric. In some examples, the substrate comprises at least one of: silicon (Si), gallium (Ga), germanium (Gr), lithium niobate (LiNbO₃), graphene (C), indium (In), or an alloy, oxide, nitride, or phosphide of at least one of such.

In some examples, a portion, a layer, or a substrate herein is a single layer of the same homogenous material, though it is envisaged for other examples that a portion instead comprises one or more sub-layers or sub-portions each deposited or formed independently of each other (e.g., one after another during a fabrication process to form a stack of sub-layers which together could be considered a layer). A layer or a portion may have sub-portions of different materials, for example, for fabrication. Sub-portions of a layer or a portion may have different dopant concentrations.

In some examples at least one of: the waveguide, the first waveguide portion, the second waveguide portion, or the material comprises indium gallium arsenide phosphide (InGaAsP).

In some examples, any of the portions, substrates, waveguides, layers, or material, described herein, comprises at least one of a semiconductor, a dielectric, or a polymer.

In various examples, at least one of the waveguide, cladding, space, or material described herein, comprises at least one of Si, InP, gallium arsenide (GaAs), gallium antimonide (GaSb), gallium nitride (GaN), indium gallium arsenide (InGaAs), indium gallium arsenide phosphide (InGaAsP), indium aluminium arsenide (InAlAs), indium aluminium gallium arsenide (InAlGaAs), AlGaAs, InGaAsP, SiN, silicon oxide (SiO2), tantalum pentoxide (Ta2O5 or tantala), aluminium oxide (Al2O3, or alumina), aluminium nitride (AlN) or lithium niobate (LiNbO3). Other materials are envisaged in further examples. In the described Figures, dashed lines are included at the edges of certain parts to indicate continuation of the parts in question beyond what is schematically illustrated in the Figures. The Figures include schematic illustrations of structures related to the described examples of the semiconductor structures. None of the Figures should be taken to indicate precise proportions with respect to any other Figure.

It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

1. A spot-size converter for a photonic integrated circuit, comprising:
a substrate;
a waveguide comprising:
a first waveguide portion on a first portion of the substrate; and
a second waveguide portion on a second portion of the substrate,
a size of the first waveguide portion in a first direction perpendicular to a light propagation direction of the waveguide less than a size of the second waveguide portion in the first direction.

2. The spot-size converter according to claim 1, wherein a size of the first waveguide portion in a second direction at a first location along the light propagation direction of the waveguide is greater than a size of the first waveguide portion in the second direction at a second location along the light propagation direction of the waveguide, the first location is between the second waveguide portion and the second location, and the second direction is perpendicular the first direction and the light propagation direction of the waveguide.

3. The spot-size converter according to claim 1, wherein a size of the second waveguide portion in a second direction at a third location along the light propagation direction is less than a size of the second waveguide portion in the second direction at a fourth location along the light propagation direction, the third location closer to the first waveguide portion than the fourth location, and the second direction is perpendicular the first direction and the light propagation direction of the waveguide.

4. The spot-size converter according to claim 1, wherein the first waveguide portion is spaced from the substrate, a distance in the first direction between the substrate and the first waveguide portion less than the size of the second waveguide portion in the first direction.

5. The spot-size converter according to claim 1, the waveguide comprising a material between the first waveguide portion and the second waveguide portion, a refractive index of the material different to both a refractive index of the first waveguide portion and a refractive index of the second waveguide portion.

6. The spot-size converter according to claim 1, wherein at least one of:
(i) a size of the first waveguide portion in the first direction at the first location along the light propagation direction is greater than a size of the first waveguide portion in the first direction at the second location along the light propagation direction; or
(ii) a size of the second waveguide portion in the first direction at a third location along the light propagation direction is less than a size of the second waveguide portion in the first direction at a fourth location along the light propagation direction, and the third location is closer to the first waveguide portion than the fourth location.

7. The spot-size converter according to claim 1, wherein at least one of:
(i) a size of the first waveguide portion in the first direction is less than the size of the second waveguide portion in the first direction, such that a surface of the first waveguide portion is stepped relative to a surface of the second waveguide portion, the surface of the first waveguide portion next to the surface of the second waveguide portion; or
(ii) a size of the second waveguide portion in a second direction at a third location along the light propagation direction is greater than a size of the second waveguide portion in the second direction at a fourth location along the light propagation direction, the third location closer to the first waveguide portion than the fourth location, and the second direction is perpendicular the first direction and the light propagation direction of the waveguide.

8. The spot-size converter according to claim 1, configured for a first spot-size conversion and a second spot-size conversion, and at least one of:
(i) the first spot size conversion at least one of: greater in magnitude than a second spot-size conversion, lesser in magnitude than the second spot-size conversion, or substantially equal in magnitude to the second spot-size conversion;
(ii) the first spot-size conversion is an increase of spot-size in a second direction for light propagating through the first waveguide portion away from the second waveguide portion, and the second direction is perpendicular the first direction and the light propagation direction of the waveguide;
(iii) the second spot-size conversion is an increase of spot-size in the first direction for light propagating from the second waveguide portion to the first waveguide portion;
(iv) the first waveguide portion and the second waveguide portion are of the same material;
(v) the substrate, the first waveguide portion and the second waveguide portion are monolithically integrated into the spot size converter;
(vi) the first direction is substantially perpendicular to a surface of the substrate; or
(vii) the first direction is substantially parallel to a surface of the substrate.

9. The spot-size converter according to claim 1, comprising:
(i) a cladding material in contact with the first waveguide portion; or
(ii) a cladding material in contact with the first waveguide portion, a first refractive index of the cladding material between 0.05 and 0.3 less than a second refractive index of the first waveguide portion.

10. A photonic integrated circuit comprising a spot-size converter comprising:
a substrate;
a waveguide comprising:
a first waveguide portion on a first portion of the substrate; and
a second waveguide portion on a second portion of the substrate,
a size of the first waveguide portion in a first direction perpendicular to a light propagation direction of the waveguide less than a size of the second waveguide portion in the first direction.

11. The photonic integrated circuit according to claim 10, wherein an end of the first waveguide portion is configured for at least one of:
connection with a waveguide external to the photonic integrated circuit;
coupling light into the photonic integrated circuit; or
coupling light out of the photonic integrated circuit.

12. A method of manufacturing a spot-size converter for a photonic integrated circuit, the method comprising:
providing a substrate; and
at least partly forming a waveguide comprising:
at least partly forming a first waveguide portion on a first portion of the substrate, and
at least partly forming a second waveguide portion on a second portion of the substrate,
a size of the first waveguide portion in a first direction perpendicular to a light propagation direction of the waveguide less than a size of the second waveguide portion in the first direction.

13. The method according to claim 12, wherein a size of the first waveguide portion in a second direction at a first location along the light propagation direction of the waveguide is greater than a size of the first waveguide portion in the second direction at a second location along the light propagation direction of the waveguide, the first location is between the second waveguide portion and the second location, and the second direction is perpendicular the first direction and the light propagation direction of the waveguide.

14. The method according to claim 12, wherein a size of the second waveguide portion in a second direction at a third location along the light propagation direction is less than a size of the second waveguide portion in the second direction at a fourth location along the light propagation direction, the third location closer to the first waveguide portion than the fourth location, and the second direction is perpendicular the first direction and the light propagation direction of the waveguide.

15. The method according to claim 12, wherein the first waveguide portion is spaced from the substrate, a distance in the first direction between the substrate and the first waveguide portion less than the size of the second waveguide portion in the first direction.

16. The method according to claim 12, comprising at least partly forming a spacer between the first waveguide portion and the substrate after at least partly forming the waveguide, a size of the spacer in a second direction at a first location along the first direction is less than a size of the spacer in the second direction at a second location along the first direction, the first location closer to the first waveguide portion than the second location, and the second direction perpendicular the first direction and the light propagation direction of the waveguide.

17. The method according to claim 16, wherein at least partly forming the spacer comprises wet etching.

18. The method according to claim 12, wherein at least one of:
(i) the first waveguide portion is spaced from the second waveguide portion;
(ii) the method comprises forming a material between the first waveguide portion and the second waveguide portion, a refractive index of the material different to both a refractive index of the first waveguide portion and a refractive index of the second waveguide portion; or
(iii) the method comprises spacing the first waveguide portion and the second waveguide portion by at least one of:
removing part of the first waveguide portion,
removing part of the second waveguide portion,
etching, or
lithography.

19. The method according to claim 12, wherein at least one of:
(i) a size of the first waveguide portion in the first direction at the first location along the light propagation direction is greater than a size of the first waveguide portion in the first direction at the second location along the light propagation direction, and the first location is closer to the first waveguide portion than the second location; or
(ii) a size of the second waveguide portion in the first direction at a third location along the light propagation direction is less than a size of the second waveguide portion in the first direction at a fourth location along the light propagation direction, and the third location is closer to the first waveguide portion than the fourth location.

20. The method according to claim 12, wherein at least partly forming the waveguide comprises:
depositing a first waveguide material of a first thickness on the substrate;
partly removing the first waveguide material of the first thickness to provide an exposed portion of the substrate; and
depositing a second waveguide material of a second thickness on the exposed portion of the substrate.

21. The method according to claim 20, comprising depositing a cladding material on the first waveguide material before partly removing the first waveguide material of the first thickness to expose the second portion of the substrate.

22. The method according to claim 20, wherein:
(i) the method comprises partly removing the second waveguide material of the second thickness to provide the second waveguide portion;
(ii) the method comprises partly removing the second waveguide material of the second thickness to provide the second waveguide portion and depositing cladding material to contact the sides of the first waveguide portion which extend away from the substrate; or
(iii) the second waveguide portion comprises the first waveguide material, the first thickness is greater than the second thickness, and the method comprises depositing cladding material of a third thickness on second waveguide material, wherein the second thickness and the third thickness together are substantially the same as the first thickness.
